(19) United States
(12) Patent Application Publication
(10) Pub. No.: US 2012/0174693 A1
(43) Pub. Date: Jul. 12, 2012

(54) BALL BEARING DEVICE FOR MOTION GUIDE DEVICE

(76) Inventor: Wu Teng HSIEH, Taichung (TW)

(21) Appl. No.: 13/428,069

(22) Filed: Mar. 23, 2012

Related U.S. Application Data
(63) Continuation-in-part of application No. 12/284,865, filed on Sep. 25, 2008.

(51) Int. Cl. F16H 25/22

(52) U.S. Cl. 74/424.81

(57) ABSTRACT

A motion guide device includes a rolling passage formed between two members, a number of bearing members disposed in the rolling passage and engaged between the members, and a number of spacers disposed in the rolling passage and engaged between the bearing members, the spacers each include a spherical configuration having six sides arranged opposite to each other, and each include a depression formed in each of the six sides and formed by four tilted and planar surfaces for engaging with the bearing members, and for allowing the spacers to be suitably engaged between the bearing members even when the spacers are rotated relative to the bearing members.

The present invention is a continuation-in-part of U.S. patent application Ser. No. 12/284,865, filed 25 Sep. 2008, pending and to be abandoned.

### BACKGROUND OF THE INVENTION

1. Field of the Invention

The present invention relates to a motion guide device, and more particularly to a motion guide device including a ball bearing device having a number of ball bearing members disposed between two members that are movable relative to each other and having a number of spacers disposed between the ball bearing members for suitably spacing or separating the ball bearing members from each other.

2. Description of the Prior Art Typical motion guide devices, such as linear motion guide devices, ball screw devices, ball bearing devices or the like comprise two members that are movable or slidable relative to each other, a number of ball bearing members disposed between the two sliding members for suitably spacing the two sliding members from each other and for allowing the two sliding members to be smoothly moved or slid relative to each other.

For example, U.S. Pat. No. 5,096,308 to Sundseth discloses one of the typical ball units also comprising a number of ball bearing members disposed between a formed base member and a load-bearing ball for bearing and facilitating the relative sliding movement between the formed base member and the load-bearing ball. However, no spacers have been provided between the ball bearing members such that the ball bearing members may have a good chance to be interfered with each other.

U.S. Pat. No. 6,652,146 to Lee discloses another typical linear motion guide device comprising two offset ball rows disposed between two members that are movable or slidable relative to each other, and a number of spacers disposed between the ball bearing members for suitably spacing or separating the ball bearing members from each other and for preventing the ball bearing members from interfering with each other.

However, the spacers each include only two recesses formed in the opposite sides for receiving or engaging with the ball bearing members, and the spacers may not be suitably engaged with the ball bearing members when the spacing distance between the ball bearing members is increased.

U.S. Application Publication Patent No. US 2004/0000208 A1 to Michioka et al. discloses a further typical motion guide device comprising a nut rotatably attached or engaged or assembled onto a screw shaft, and a number of ball bearing members disposed in a ball rolling passage formed by a ball rolling groove formed to the screw shaft and a loaded ball rolling groove formed to the nut, and a number of spacers disposed between the ball bearing members in the ball rolling passage, and a circulation member for circulating the ball bearing members and the spacers in accordance with a relative motion of the nut with respect to the screw shaft.

However, similarly, the spacers each also include only two recesses formed in the opposite sides for receiving or engaging with the ball bearing members, and the spacers may not be suitably engaged with the ball bearing members when the spacing distance between the ball bearing members is increased.

U.S. Pat. No. 7,263,908 to Osterlanger et al. discloses a still further typical motion guide device comprising a number of ball bearing members for being disposed in a ball rolling passage formed by a ball rolling groove formed to a screw shaft and a loaded ball rolling groove formed to a nut, and a number of spacers disposed between the ball bearing members in the ball rolling passage.

However, the spacers include a non-symmetric structure having only two opposite recesses formed in the opposite sides for receiving or engaging with the ball bearing members, and the spacers may not be suitably engaged with and between the ball bearing members when the other sides are faced and directed and engaged with and between the ball bearing members.

The present invention has arisen to mitigate and/or obviate the afore-described disadvantages of the conventional linear motion guide devices, ball screw devices or ball bearing devices.

The present invention has arisen to mitigate and/or obviate the afore-described disadvantages of the conventional motion guide devices.

### SUMMARY OF THE INVENTION

The primary objective of the present invention is to provide a motion guide device including a ball bearing device having a number of ball bearing members disposed between two movable members that are movable relative to each other and having a number of spacers disposed between the ball bearing members for suitably spacing or separating the ball bearing members from each other.

The other objective of the present invention is to provide a motion guide device including a ball bearing device having the smaller spacers and the greater bearing members for allowing the spacers to be suitably rotated relative to the bearing members and for preventing the spacers from interfering the movement of the ball bearing members.

The further objective of the present invention is to provide a motion guide device including a ball bearing device having the bearing member engaged with the spacer in four contact points for decreasing the contact area between the spacers and the ball bearing members.

In accordance with one aspect of the invention, there is provided a motion guide device comprising a first member and a second member including a rolling passage formed between the first and the second member, a plurality of bearing members disposed in the rolling passage and engaged between the first and the second members for facilitating a movement between the first and the second members, and a plurality of spacers disposed in the rolling passage and engaged between the bearing members for spacing the bearing members from each other, the spacers including an outer diameter smaller than an outer diameter of the bearing members, wherein the spacers each include a substantially spherical configuration having six sides which include a first side, a second side, a third side, a fourth side, a fifth side, and a six side, the first and the third sides are arranged opposite to each other, and the second and the fourth sides are arranged opposite to each other, and the fifth and the six sides are arranged opposite to each other, and the spacers each include a depression formed in each of the six sides and formed and defined by four tilted and planar surfaces for engaging with the bearing members, and for allowing the spacers to be engaged between the bearing members and for allowing the bearing members to be engaged between the spacers relatively.

A proportion between the outer diameter of the spacers and the outer diameter of the bearing members is ranged between 1˜0.8:1.

The bearing member is engaged with the surfaces of the spacer in four contact points.

The surfaces of the spacers each include a sector-shape. The surfaces of the spacers are identical in structure to each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a motion guide device or motion guide device in accordance with the present invention, in which a portion of the motion guide device has been cut off for showing an inner structure of the motion guide device;

FIG. 2 is a perspective view illustrating the ball bearing device for the motion guide device;

FIG. 3 is a perspective view illustrating one of the spacers of the ball bearing device;

FIG. 4 is a partial plan schematic view of the motion guide device;

FIG. 5 is a partial cross sectional view of the motion guide device taken along lines 5-5 of FIG. 4; and

FIG. 6 is a plan schematic view illustrating the spacer of the motion guide device.

### DETAILED DESCRIPTION OF THE PREFERRED EMBODIMENT

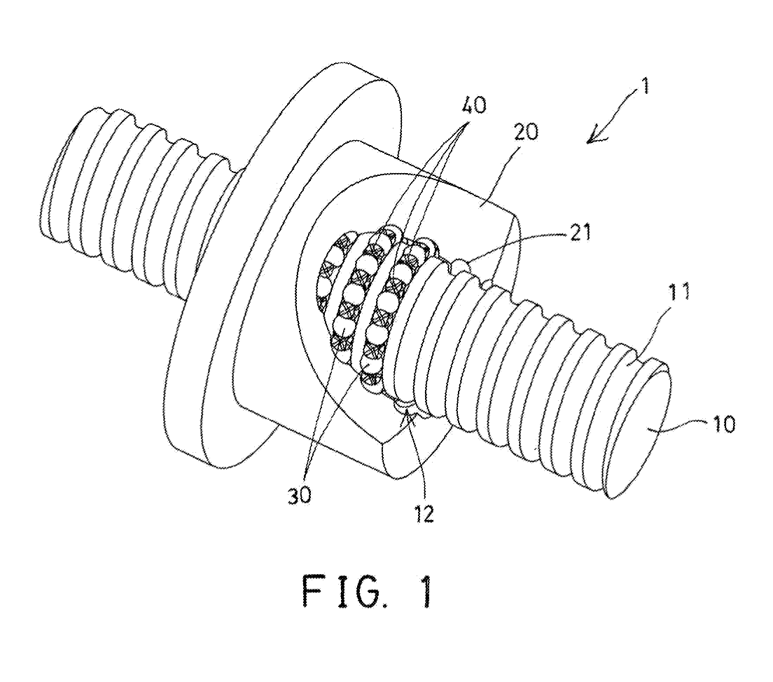

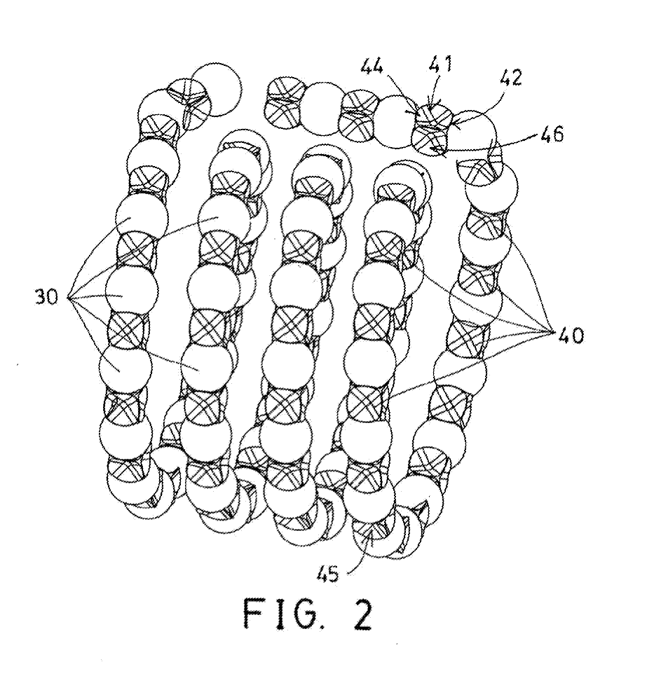

Referring to the drawings, and initially to FIG. 1, a motion guide device 1, such as a linear motion guide device, a ball screw device, a ball bearing facility or the like in accordance with the present invention comprises two members 10, 20, such as a first member 10 and a second member 20, or a screw shaft 10 and a nut 20 each including a ball rolling groove 11, 21 formed therein and aligned with each other for forming one or more endless ball rolling passages 12 therein or between the screw shaft 10 and the nut 20, a number of bearing members 30 disposed between the two movable or sliding members 10, 20 for suitably spacing the two movable or sliding members 10, 20 from each other and for allowing the two movable or sliding members 10, 20 to be smoothly moved or slid relative to each other, or for facilitating the movement between the two movable or sliding members 10, 20, and a number of spacers 40 disposed between the bearing members 30 (FIGS. 1, 2) for suitably spacing or separating the bearing members 30 from each other and for allowing the bearing members 30 to be suitably engaged between the two members 10, 20.

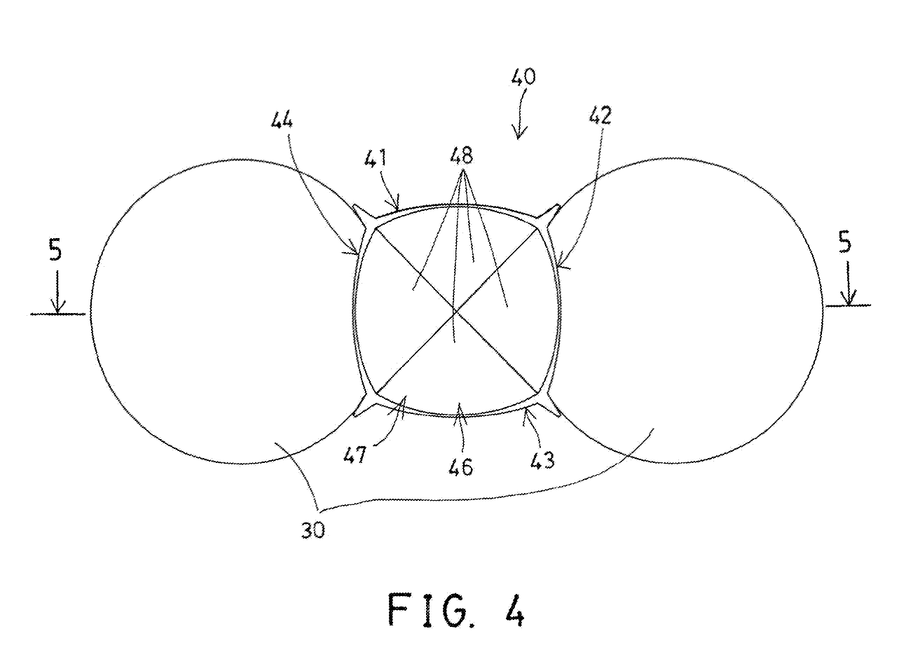

As shown in FIGS. 2-6, the spacers 40 each include a substantially spherical outer appearance or structure or configuration having six sides 41, 42, 43, 44, 45, 46, in which the two sides 41, 43 are arranged opposite to each other, and the other two sides 45, 46 are arranged opposite to each other, and the further two sides 42, 44 are arranged opposite to each other, and the spacers 40 each include a depression 47 formed in each of the six sides 41-46 for suitably receiving or engaging with the ball bearing members 30, as best shown in FIGS. 1-2 and 4-5, and for allowing the spacers 40 to be suitably disposed or engaged between the ball bearing members 30, or for allowing the ball bearing members 30 to be suitably disposed or engaged between the spacers 40 relatively. As shown in FIG. 4, the spacers 40 each include an outer diameter “d” smaller than the outer diameter “D” of the ball bearing members 30 for preventing the spacers 40 from interfering the movement of the ball bearing members 30.

It is preferable that the proportion between the outer diameters “d” of the spacers 40 and the outer diameters “D” of the ball bearing members 30 is ranged between 1.about.0.8:1 for allowing the spacers 40 to be suitably rotated relative to the bearing members 30 and for preventing the spacers 40 from interfering the movement of the ball bearing members 30. It is to be noted that the spacing distance between the ball bearing members 30 will be increased or enlarged after use, due to friction or the like, and the spacers 40 may have a good chance to be rotated relative to the ball bearing members 30, and the formation or the provision of the six depressions 47 in each of the spacers 40 allows the ball bearing members 30 to be suitably engaged with the depressions 47 in the opposite sides 41, 43; 45, 46; 42, 44 of the spacers 40 even after the spacers 40 have been rotated relative to the ball bearing members 30, and thus for allowing the bearing members 30 to be suitably disposed or engaged between the spacers 40, or for allowing the spacers 40 to be suitably disposed or engaged between the ball bearing members 30 relatively.

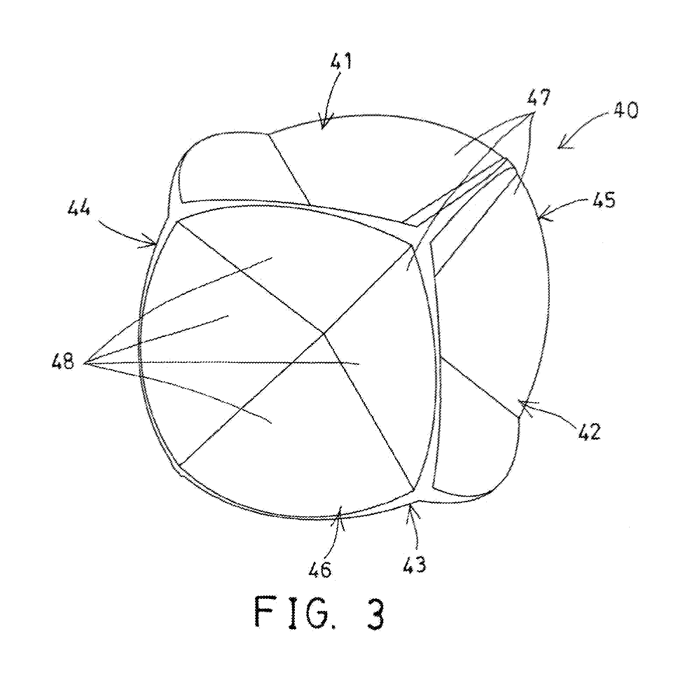

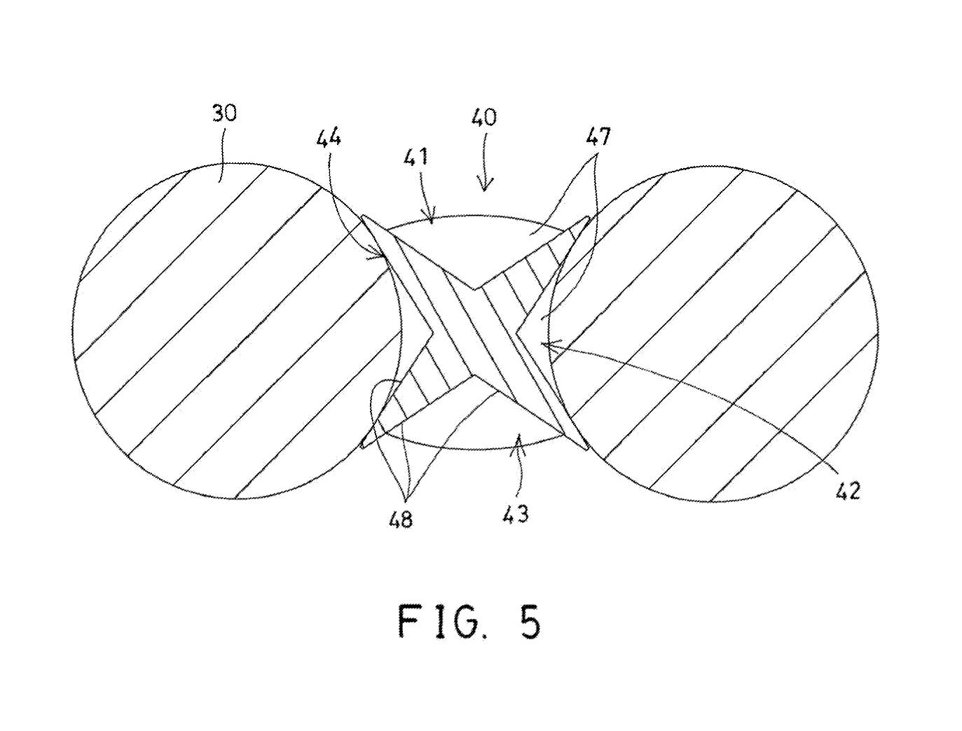

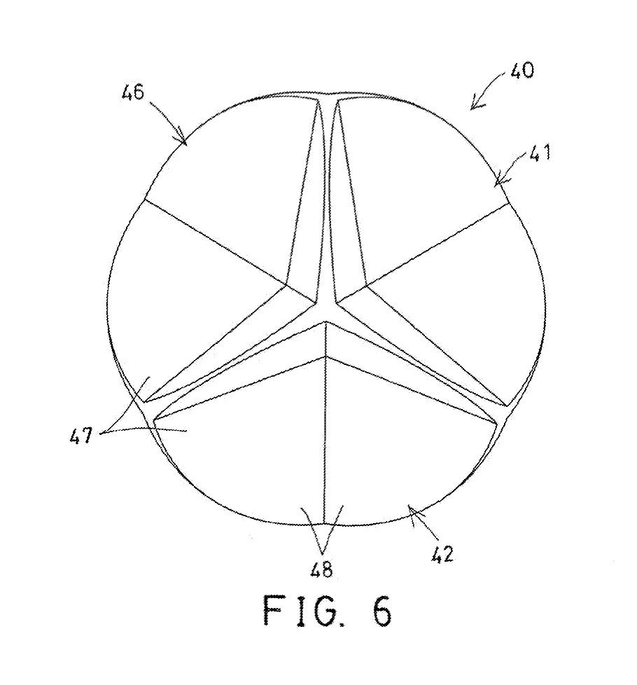

As best shown in FIGS. 3-6, the spacers 40 each further include four tilted or inclined and planar surfaces 48 each of which include a sector-shape, for forming or defining the depression 47 thereof, or the depressions 47 of the spacers 40 are identical in structure to each other and each formed or defined by four tilted or inclined and planar surfaces 48 for allowing the bearing members 30 to be engaged with the spacers 40 in four contact points (FIG. 5) and for suitably decreasing the contact area between the spacers 40 and the ball bearing members 30. As best shown in FIG. 6, when viewing from one of the angles of the spacer 40, the spacer 40 includes a structure arranged for allowing the spacers 40 to be easily and quickly manufactured with molding or mold-injection procedures and to be easily and quickly removed or disengaged from the mold devices.

In operation, as shown in FIGS. 1-2 and 4-5, the ball bearing members 30 may be suitably received or engaged with the depressions 47 in the opposite sides 41, 43; 45, 46; 42, 44 of the spacers 40 even after the spacers 40 have been rotated relative to the ball bearing members 30, such that the bearing members 30 may be suitably disposed or engaged between the spacers 40, or such that the spacers 40 may be suitably disposed or engaged between the ball bearing members 30 relatively, and such that the bearing members 30 may be suitably disposed or engaged between the two movable or sliding members 10, 20 for suitably spacing the two movable or sliding members 10, 20 from each other and for allowing the two movable or sliding members 10, 20 to be smoothly moved or slid relative to each other.

Accordingly, the motion guide device in accordance with the present invention includes a ball bearing device having a number of ball bearing members disposed between two movable members that are movable relative to each other and having a number of spacers disposed between the ball bearing members for suitably spacing or separating the ball bearing members from each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A motion guide device comprising:
a first member and a second member including a rolling passage formed between said first and said second member,
a plurality of bearing members disposed in said rolling passage and engaged between said first and said second members for facilitating a movement between said first and said second members, and
a plurality of spacers disposed in said rolling passage and engaged between said bearing members for spacing said bearing members from each other, said spacers including an outer diameter smaller than an outer diameter of said bearing members,
wherein said spacers each include a substantially spherical configuration having six sides which include a first side, a second side, a third side, a fourth side, a fifth side, and a six side, said first and said third sides are arranged opposite to each other, and said second and said fourth sides are arranged opposite to each other, and said fifth and said six sides are arranged opposite to each other, and said spacers each include a depression formed in each of said six sides and formed and defined by four tilted and planar surfaces for engaging with said bearing members, and for allowing said spacers to be engaged between said bearing members and for allowing said bearing members to be engaged between said spacers relatively.

2. The motion guide device as claimed in claim 1, wherein a proportion between said outer diameter of said spacers and said outer diameter of said bearing members is ranged between 1˜0.8:1.

3. The motion guide device as claimed in claim 1, wherein said bearing member is engaged with said surfaces of said spacer in four contact points.

4. The motion guide device as claimed in claim 1, wherein said surfaces of said spacers each include a sector-shape.

5. The motion guide device as claimed in claim 1, wherein said surfaces of said spacers are identical in structure to each other.
